(19) United States
(12) Patent Application Publication
(10) Pub. No.: US 2008/0236688 A1
(43) Pub. Date: Oct. 2, 2008

(54) Gas Valve Assembly for a Barbecue

(75) Inventor: Inigo Albizuri, Muxika (Bizkaia) (ES)

Correspondence Address: BERENBAUM, WEINSHIENK & EASON, P.C, 370 17TH STREET, SUITE 4800, DENVER, CO, 80202, US

(73) Assignee: COPRECITEC, S.L., Aretxabaleta (Gipuzkoa) (ES)

(21) Appl. No.: 12/054,238

(22) Filed: Mar. 24, 2008

(30) Foreign Application Priority Data
Mar. 26, 2007 (ES) U200700654

(51) Int. Cl. F16K 27/00; F16K 11/20

(52) U.S. Cl. 137/883; 251/151; 137/887

(57) ABSTRACT

A gas valve assembly for a barbecue is provided. The assembly includes a distributor that has a gas inlet conduit and a diversion conduit connected to the inlet conduit, the diversion conduit having branches through which the inlet gas is distributed, and control valves adapted for their connection to a burner, each control valve having a main body and a connection conduit extending therefrom. The connection conduit of each control valve is partially housed inside a respective branch of the diversion conduit. Retainers that are independent to the connection conduit and the distributor pass through grooves or holes in the respective branches and connection conduits to affix, or to ensure fixation, of the valves to the distributor.

### CROSS-REFERENCE TO RELATED APPLICATION

This application claims priority as a regular U.S. Utility Application from the Spanish Application No. U200700654 filed on Mar. 26, 2007, the subject matter of which hereby being incorporated by this reference herein in its entirety as though fully set forth herein.

### TECHNICAL FIELD

The present invention relates to a gas valve and distributor assembly adapted for connection to a barbecue and, specifically, to the fixing of control valves to a distributor.

### BACKGROUND

Outdoor gas barbecues which are operated by multiple gas valves are known. Dual gas valve assemblies, for example, generally comprise a pair of control valves that control the passage of gas towards individual burners located in the barbecue and a distributor connected to a gas supply conduit that diverts the gas towards said control valves. Conventional distributors comprise a plurality of branches threaded internally and externally for their connection to the corresponding control valve. These types of threaded connections usually slow down the assembly and also make the process of manufacture of the elements making up the dual valve more costly.

Another of the problems presented by this type of threaded connection is the correct positioning of the control valves in relation to the distributor. It is known that said control valves, more specifically the shafts of said control valves, must be inserted into housings disposed on the plate of the barbecue, where they are coupled to control levers, it being necessary for said shafts to be positioned concentrically in relation to said housings. It is necessary, therefore, that said control valves are correctly aligned, which is not always easy to achieve by means of threaded connections. Known threaded connections for fixing control valves to the distributor comprise a conic frustrum thread that moves inside a cylindrical thread of the distributor, said conic frustrum thread gradually being compressed during its movement.

In addition, this type of threaded connection restricts to a certain extent the use of materials in the manufacture of gas valves due to the compression suffered by the threaded element. Thus, for example, the use of brass in this type of thread is known, but not aluminium, as said material cannot withstand significant compressions, with the thread breaking easily.

U.S. Pat. No. 6,199,589 B1 discloses a dual valve assembly that comprises a pair of control valves and a distributor connected to said control valves. The distributor comprises a gas inlet with a central axis, and a first and second diversion branch, both symmetrical in relation to the central axis, and each control valve comprises a main body with a cylindrical extension that extends towards the exterior continuously from said main body and which is housed in the first and second branch respectively of the distributor. For the fixing of said extensions to the distributor, each diversion branch has a flat end bent towards the inside of the branch, and the cylindrical extension of each control valve includes a flat part so that once it has been fixed by means of the internal bend, the control valve is prevented from rotating. In other embodiments an O-ring seal is also added between the cylindrical extensions inserted inside the branch in order to improve the sealing of the connection.

### SUMMARY OF THE DISCLOSURE

An object of the invention is to provide a gas valve assembly adapted for connection to a barbecue as it is defined in the claims and as described herein.

In one embodiment a dual gas valve assembly is provided that comprises a distributor that has a gas inlet conduit, and a diversion conduit connected to said inlet conduit and which comprises branches through which the inlet gas is distributed, and control valves adapted for their connection to a burner, each control valve comprising a main body and a connection conduit that extends continuously projecting itself from a lateral or other surface of said main body, the connection conduit of each control valve being fixed to each respective branch of the diversion conduit. The connection conduit of each control

Valve is partially housed inside each respective branch.

The gas valve assembly also comprises retainers that ensure the fixing of the control valves to said distributor, said retainers being independent to the connection conduit and the distributor and said retainers passing through the diversion conduit and the connection conduit housed within the diversion conduit with the object of keeping said control valves fixed to the distributor. This type of fixing system simplifies the process of manufacture of the pieces, and as it avoids threaded connections, the assembly achieves a gas-tight connection and also prevents the incorrect positioning of each control valve in relation to the distributor as well as preventing said control valves rotating on the distributor once the unit has been assembled.

These and other advantages and characteristics of the invention will be made evident in the light of the drawings and the detailed description thereof.

### DESCRIPTION OF THE DRAWINGS

FIG. 1 is an exploded view of an embodiment of a valve assembly according to the invention.

FIG. 2 is a three-dimensional view of the valve assembly of FIG. 1, assembled.

FIG. 3 is a ground view of the distributor built into the valve assembly of FIG. 1.

FIG. 4 is a lateral view of the distributor built into the valve assembly of FIG. 1.

FIG. 5 is a cross-sectional view of the distributor of FIG. 3 according to the V-V line.

FIG. 6 is a front view of one of the two control valves built into the valve assembly of FIG. 1.

FIG. 7 is a top view of one of the two control valves built into the valve assembly of FIG. 1.

FIG. 8 is a lateral view of one of the two control valves built into the valve assembly of FIG. 1.

FIG. 9 is a front view of a second embodiment of a retainer of the distributor and the control valves of FIG. 1.

FIG. 10 is a cross-sectional view of the connection of the control valve to the distributor through the retainer shown in FIG. 9.

### DETAILED DESCRIPTION

In the following description, numerous specific details are set forth in order to provide a thorough understanding of the present invention. It will be understood, however, to one skilled in the art, that the present invention may be practiced without some or all these specific details. In other instances, well known process operations have not been described in detail in order not to unnecessarily obscure the present invention.

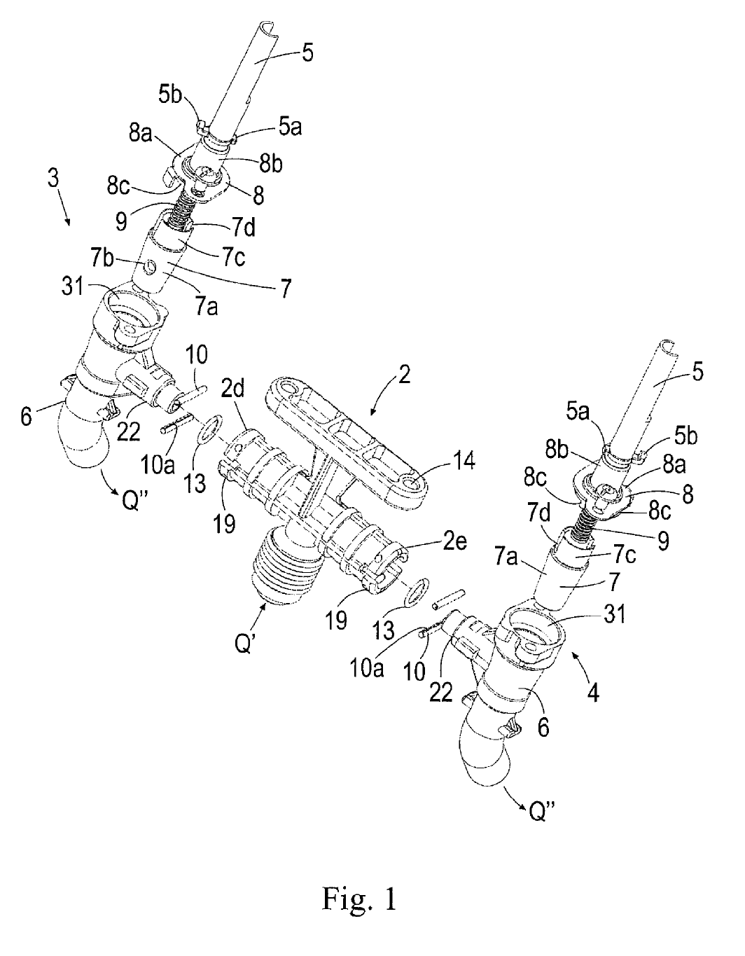

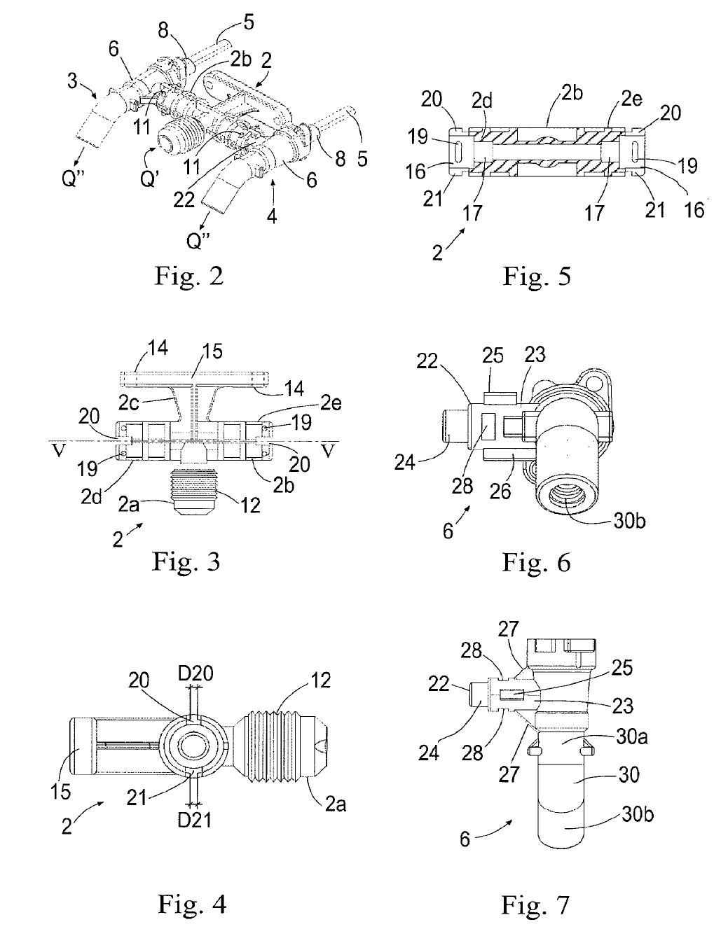

FIGS. 1 and 2 show a gas valve assembly adapted to a barbecue (not shown in the figures) in an embodiment of the invention. The gas valve assembly comprises a distributor 2 that distributes an inlet gas Q′ towards control valves 3 and 4, disposed on both sides of said distributor 2.

The distributor 2, shown in detail in FIGS. 3 to 5, is made of a lightweight, malleable material, preferably aluminium, and preferably obtained by an injection procedure. Said distributor 2 has a gas inlet conduit 2a and a substantially cylindrical diversion conduit 2b, which is connected to said inlet conduit 2a and which distributes the inlet gas Q′ through branches 2d and 2e of said diversion conduit 2b, said branches 2d and 2e being coaxial. In alternative embodiments branches 2d and 2e are not coaxial.

In one embodiment the inlet conduit 2a is disposed perpendicularly and symmetrically in relation to said diversion conduit 2b, substantially forming a “T” with said diversion conduit 2b and it has an external thread 12 through which said distributor 2 is fixed to a gas conduit not shown in the Figures. The distributor 2 also includes a support element 2c that extends continuously and perpendicularly in the form of a “T”, from a lateral surface of the diversion conduit 2b, so that its axis of symmetry coincides with the axial axis of the inlet conduit 2a. The base 15 of the support element 2c comprises symmetrical fixing holes 14 for the fixing of the valve assembly to a support of the barbecue not shown in the Figures. Other types of support elements which are capable of fixing the valve assembly to a support of a barbecue may also be used.

The diversion conduit 2b at each branch 2d and 2e has a first housing 16 and a second housing 17, said second housing 17 being of a smaller diameter and depth than the first housing 16, and said first housing 16 and second housing 17 being cylindrical and coaxial with the diversion conduit 2b.

In the embodiments of FIGS. 1 and 2 the control valves 3 and 4, which are fixed to each respective branch 2d and 2e of the diversion conduit 2b, are specular to each other and, as a result, one of them will be described from this point onwards, said description being valid for the corresponding specular area. In alternative embodiments of the invention the control valves are neither specular nor identical to one another.

The control valve 3 shown in its entirety in FIGS. 1 and 2 comprises a valve shaft 5 adapted on one end for the fixing of a control lever not shown in the Figures, a main body 6 with a connection conduit 22 that is fixed to an end of the branch 2d of the diversion conduit 2b, a regulator element 7 coupled to the valve shaft 5 and inserted into said main body 6, and a fixing support 8 that connects the valve shaft 5 to said main body 6.

Said fixing support 8 has a base plate 8a with ears that are screwed to the main body 6, a cylindrical prolongation 8b that extends axially from one of the surfaces of the base plate 8a, housing the valve shaft 5 in its interior, and peripheral edges 8c that extend axially from the opposite surface of the base plate 8a, and which are housed in the cavity 31 of the main body 6. The valve shaft 5 is disposed with an end, a first flat radial tab 5a and a second radial tab 5b that extends longitudinally according to the axial axis of said valve shaft 5, which come up against the base plate 8a thereby preventing the disassembly of the valve shaft 5 in relation to the valve body 6.

Additionally the regulator element 7 comprises a hollow main member 7a with a substantially conic frustrum shape, which includes a through hole 7b on the lateral surface, so that to enable the passage of gas Q″ to the burners, the regulator element 7 must be rotated by means of the lever until said through hole 7b coincides with the connection conduit 22 of the main body 6. Said regulator element 7 also comprises a cylindrical body 7c that extends axially from the main member 7a, a spring 9 being housed in its interior and whose other end comes up against the base plate 8a, and with said cylindrical body 7c including a pair of coaxial cuts 7d in which are housed the radial tabs 5a and 5b of the valve shaft 5.

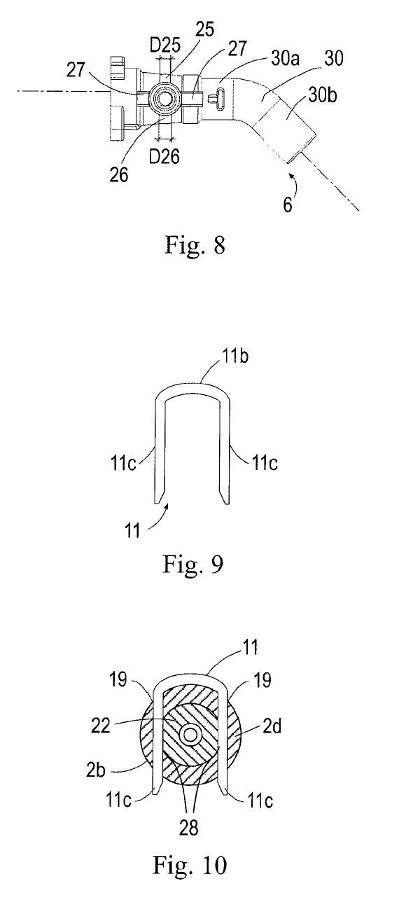

Furthermore, the main body 6 of revolution, shown in detail in FIGS. 6 to 8, has a cavity 31 in which is housed the conic frustrum regulator element 7 and an outlet conduit 30 with a first part 30a typically coaxial with said regulator element 7 and connected to said cavity 31, and with a second part 30b whose axial axis may form an angle with the axial axis of the first part 30a, said second part 30b being threaded internally for its fixing to a burner.

As shown in the exemplary embodiments depicted in the Figures, the substantially cylindrical connection conduit 22 extends continuously from the lateral surface of the main body 6, so that the axial axis is substantially perpendicular to the axial axis of said main body 6, and has a first segment 23 continuous with the lateral surface of the body 6 and a second segment 24 coaxial with and adjacent to said first segment 23 and of a smaller diameter and length than said first segment 23. Said first segment 23 includes a pair of radial projections 25 and 26, which in a preferred embodiment are disposed diametrically opposed to each other and symmetrical in relation to the axial axis of the main body 6. The first projection 25 being of a width D25 and the second projection 26 of a width D26, so that the width D25 is greater than the width D26. In alternative embodiments, the first and second projections are not diametrically opposed.

For the correct positioning of the respective control valves 3 and 4 in relation to the distributor 2, the diversion conduit 2b includes on the end of each branch 2d and 2e, a first groove 20 and a second groove 21 which, in a preferred embodiment, are axial and diametrically opposed to each other, the width D20 of the first groove 20 being greater than the width D21 of the second groove 21. The two first grooves 20 are preferably symmetrically aligned with each other in relation to the axial axis of the diversion conduit 2b, as are the two second grooves 21. As a result, when the connection conduit 22 is coupled to the distributor 2, the first radial projection 25 is housed tightly in the first groove 20 and the second radial projection 26 is housed tightly in the second groove 21, the width D21 of the second groove 21 being smaller than the width D25 of the first projection 25 in order to prevent assembly errors. In an embodiment, the connection conduit 22 is reinforced by means of a pair of ribs 27, situated in the connection of said connection conduit 22 to the main body 6, and are typically coplanar to each other and perpendicular in relation to the first projection 25 and second projection 26.

When the control valves 3 and 4 are assembled in the respective branches 2d and 2e of the distributor 2, the first segment 23 of the connection conduit 22 is partially housed tightly inside the first housing 16 while the second segment 24 is wholly housed tightly inside the second housing 17, said second segment 24 comprising an O-ring seal, or other suitable sealing means 13 fitted against its exterior wall with the object of creating a gas-tight connection.

The dual valve comprises retainers 10, shown in FIGS. 1 and 2, for the fixing of the control valves 3 and 4 to the distributor 2. The retainers 10 comprise elongate members, such as two elastic rods, symmetrically disposed in relation to the axial axis of the diversion conduit 2b of the distributor 2, said rods 10 being independent to the connection conduit 22 and the distributor 2, and passing transversally through said connection conduit 22 and said diversion conduit 2b for their fixing. In one embodiment said rods 10 are hollow and include an axial through opening 10a that run along their length in order to facilitate their assembly and fixing and to prevent unwanted disassembly.

The diversion conduit 2b includes transversal fixing holes 19, preferably disposed symmetrically on each side of the first groove 20 and the second groove 21, which pass through said diversion conduit 2b, and the connection conduit 22 of the main body 6 comprises in the first segment 23 receptacles in the form of transversal holes or grooves 28 (as shown), so that the rods 10 pass through said fixing holes 19 and are housed in said receptacles. The fixing holes 19 and the receptacles are disposed symmetrically in relation to the axial axis of the diversion conduit 2b.

In another embodiment, the invention comprises some or all of the characteristics of the embodiments previously described, with the difference that instead of comprising rods 10 as retainers, it includes a pair of elastic staples 11, each one of which is fixed to one of the branches 2d and 2e of the diversion conduit 2b. The staple 11, shown in detail in FIGS. 9 and 10, has a central part 11b in the form of an arch adaptable to the external surface of the branch 2d, from the ends of which extend parallel arms 11c, the distance between both arms 11c being such that it is necessary to compress said arms 11c for their insertion into the respective fixing holes 19. Said arms pass through the distributor 22, being housed in the respective grooves 28 of the diversion conduit 22, said diversion conduit 22 being fixed to the distributor 2. The ends of the arms 11c project out of the diversion conduit 22 to recover, or partially recover, their initial position thereby preventing the accidental disassembly of the staple.

Other embodiments of the invention will be appreciated by those skilled in the art from consideration of the specification and practice of the invention. Furthermore, certain terminology has been used for the purpose of descriptive clarity, and not to limit the present invention. The embodiments and preferred features described above should be considered exemplary, with the invention being defined by the appended claims.

What is claimed is:

1. A gas valve assembly adapted for connection to a barbecue comprising:
a control valve adapted for connection to a burner of the barbecue having a connection conduit extending from a main body of the control valve, the connection conduit comprising one or more external receptacles,
a distributor having a gas inlet conduit and a diversion conduit connected to the inlet conduit through which an inlet gas is distributed, the connection conduit of the control valve fixed at least partially within the diversion conduit, the diversion conduit having an external surface and one or more fixation holes that are aligned with the one or more external receptacles of the connection conduit; and
a retainer independent of the connection conduit and the distributor comprising one or more elongate members that extend through the one or more fixation holes of the diversion conduit and the respective one or more external receptacles of the connection conduit to ensure the control valve remains fixed to the distributor.

2. The gas valve assembly according to claim 1, wherein the fixation holes and the external receptacles are disposed symmetrically in relation to an axial axis of the diversion conduit.

3. The gas valve assembly according to claim 1, wherein the retainer comprises a rod.

4. The gas valve assembly according to claim 3, wherein the rod is elastic, hollow and has an axial opening all the way along its length.

5. The gas valve assembly according to claim 1, wherein the retainer comprises an elastic staple that has a central part in the form of an arch adaptable to the external surface of the diversion conduit, and parallel arms that are inserted into the fixation holes and are housed in the receptacles.

6. The gas valve assembly according to claim 1, wherein the connection conduit has a first segment that is housed partially inside the diversion conduit, and a second segment that is housed wholly inside the diversion conduit, the second segment having a gas-tight seal on its exterior surface.

7. The gas valve assembly according to claim 6, wherein the second segment is coaxial with the first segment and has a smaller diameter than the first segment.

8. A gas valve assembly according to claim 6, wherein the first segment includes a first axial projection and a second axial projection which are housed respectively in first and second axial grooves disposed on an end portion of the diversion conduit.

9. A gas valve assembly according to claim 8, wherein the first and second axial projections and the respective first and second axial grooves are diametrically opposed.

10. A gas valve assembly according to claim 8, wherein the first projection is housed tightly in the first groove and the second projection is housed tightly in the second groove, the first projection being of a width greater than the width of the second groove.

11. A gas valve assembly according to claim 1, wherein the distributor is made of injected aluminium.

12. A gas valve assembly according to claim 1, wherein the control valves are made of injected aluminium.

13. A gas valve assembly adapted for connection to a barbecue comprising:
one or more control valves adapted for connection to burners of the barbecue, each control valve comprising a main body and a connection conduit projecting itself from a surface of the main body, the connection conduit of each control valve having transversal receptacles,
a distributor having a gas inlet conduit and a diversion conduit connected to the inlet conduit, the diversion conduit comprising multiple branches through which an inlet gas is distributed, the connection conduits of the control valves being fixed at least partially within a respective branch of the diversion conduit, an end portion of each branch of the diversion conduit having an external surface and transversal fixing holes aligned with respective transversal receptacles in the connection conduits of each control valve; and
retainers independent of the connection conduit and the distributor comprising one or more elongate members, the elongate members positioned within the respective transversal holes and grooves to ensure the control valve remains fixed to the distributor.

14. A gas valve assembly according to claim 13, wherein the fixing holes and the grooves are disposed symmetrically in relation to an axial axis of the diversion conduit.

15. A gas valve assembly according to claim 13, wherein one or more of the elongate members comprise rods.

16. A gas valve assembly according to claim 15, wherein one or more of the rods are elastic, hollow and have an axial through opening.

17. A gas valve assembly according to claim 13, wherein one or more of the retainers comprise an elastic staple that has a central part in the form of an arch adaptable to the external surface of the diversion conduit and having parallel arms that are inserted into the fixing holes and are housed in the receptacles.

18. A gas valve assembly according to claim 13, wherein the connection conduit has a first segment that is housed partially inside the diversion conduit, and a second segment that is housed wholly inside the diversion conduit and comprises on its exterior a gas-tight seal, the second segment being coaxial with the first segment and having a smaller diameter than the first segment.

19. A gas valve assembly according to claim 18, wherein the first segment includes first and second axial projections which are housed respectively in first and second axial grooves disposed on the branch end portion.

20. A gas valve assembly according to claim 19, wherein the first and second axial projections are diametrically opposed to one another as are their respective first and second axial grooves.

21. A gas valve according to claim 19, wherein the diversion conduit has two branches, the first and second axial grooves on one branch being symmetrically aligned with the first and second axial grooves of the other branch.

22. A gas valve assembly according to claim 19, wherein the first axial projection is housed tightly in the first axial groove and the second axial projection is housed tightly in the second axial groove, the first axial projection being of a width greater than the width of the second axial groove.

23. A gas valve assembly according to claim 13, wherein the distributor is made of injected aluminium.

24. A gas valve assembly according to claim 13, wherein the control valves are made of injected aluminium.

25. A gas valve assembly adapted for connection to a barbecue comprising:
two control valves adapted for connection to a burner of the barbecue, each control valve having a connection conduit extending from a main body of the control valve, the connection conduit comprising one or more external receptacles,
a distributor having a gas inlet conduit and a diversion conduit connected to the inlet conduit, the diversion conduit comprising two branches through which an inlet gas is distributed, the connection conduit of each control valve fixed at least partially within a respective branch of the diversion conduit, each branch having one or more fixation holes that are aligned with the one or more external receptacles of the respective connection conduit; and
a retainer independent of the connection conduits and the distributor comprising one or more elongate members that extend through the one or more fixation holes and respective one or more external receptacles to ensure the control valves remain fixed to the distributor.
